(19) United States
(12) Patent Application Publication
(10) Pub. No.: US 2019/0226274 A1
(43) Pub. Date: Jul. 25, 2019

(54) Wind Damage Abating System

(71) Applicant: Jose Magenst, Lutz, FL (US)

(72) Inventor: Jose Magenst, Lutz, FL (US)

(21) Appl. No.: 15/878,187

(22) Filed: Jan. 23, 2018

(51) Int. Cl. E06B 9/42; E06B 9/58; E04H 9/16

(52) U.S. Cl. CPC E06B 9/42; E06B 9/58; E06B 9/70; E06B 2009/583; E04H 9/16

(57) ABSTRACT

A wind damage abating system for protecting a dwelling from damaging winds includes a dwelling. A covering is mounted on a roof of the dwelling and is selectively extended downwardly from the roof to protect the dwelling from damaging winds. An extracting unit is positioned on a ground surface adjacent to the dwelling and is mechanically coupled to the covering. The extracting unit pulls the covering downwardly from the roof of the dwelling.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to dwelling protecting devices and more particularly pertains to a new dwelling protecting device for protecting a dwelling from damaging winds.

### BRIEF SUMMARY OF THE INVENTION

An embodiment of the disclosure meets the needs presented above by generally comprising a dwelling. A covering is mounted on a roof of the dwelling and is selectively extended downwardly from the roof to protect the dwelling from damaging winds. An extracting unit is positioned on a ground surface adjacent to the dwelling and is mechanically coupled to the covering. The extracting unit pulls the covering downwardly from the roof of the dwelling.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of a wind damage abating system according to an embodiment of the disclosure.

FIG. 2 is a bottom view of an embodiment of the disclosure.

FIG. 3 is a top side view of an embodiment of the disclosure.

FIG. 4 is a front view of an embodiment of the disclosure.

FIG. 5 is a top side view of an embodiment of the disclosure.

FIG. 6 is a cross-sectional view of an embodiment of the disclosure taken along line 6-6 of FIG. 4.

### DETAILED DESCRIPTION OF THE INVENTION

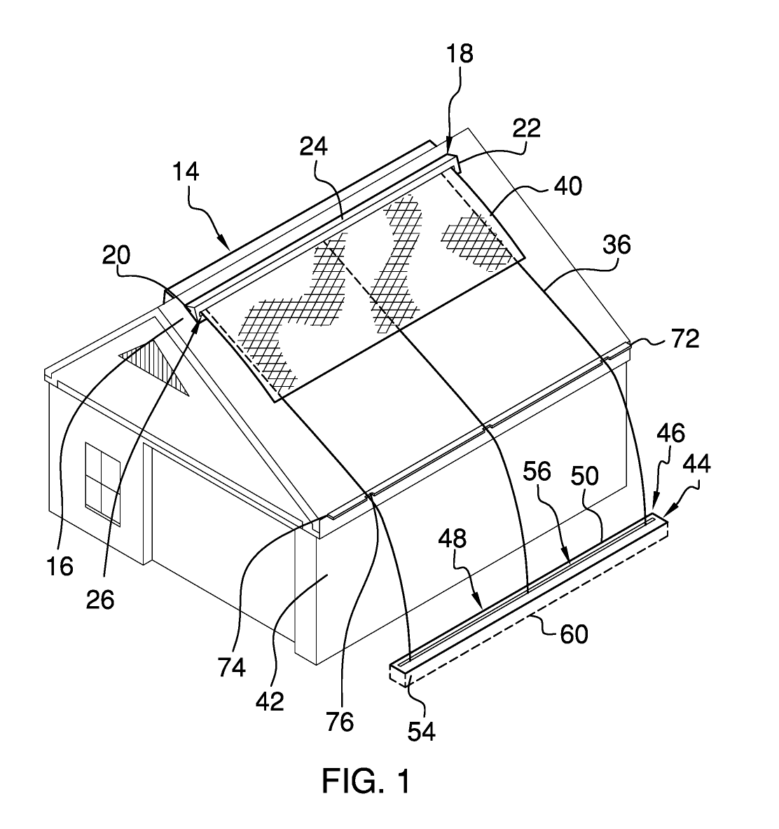

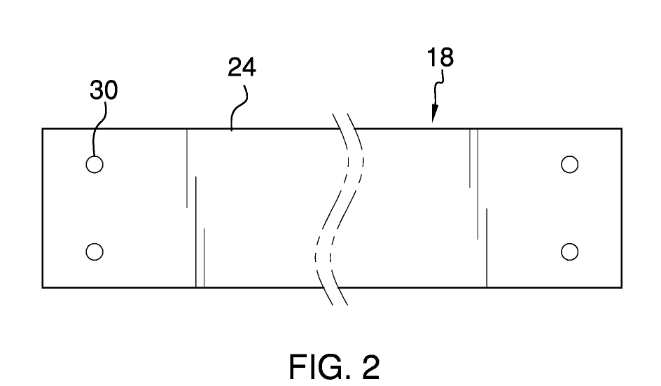

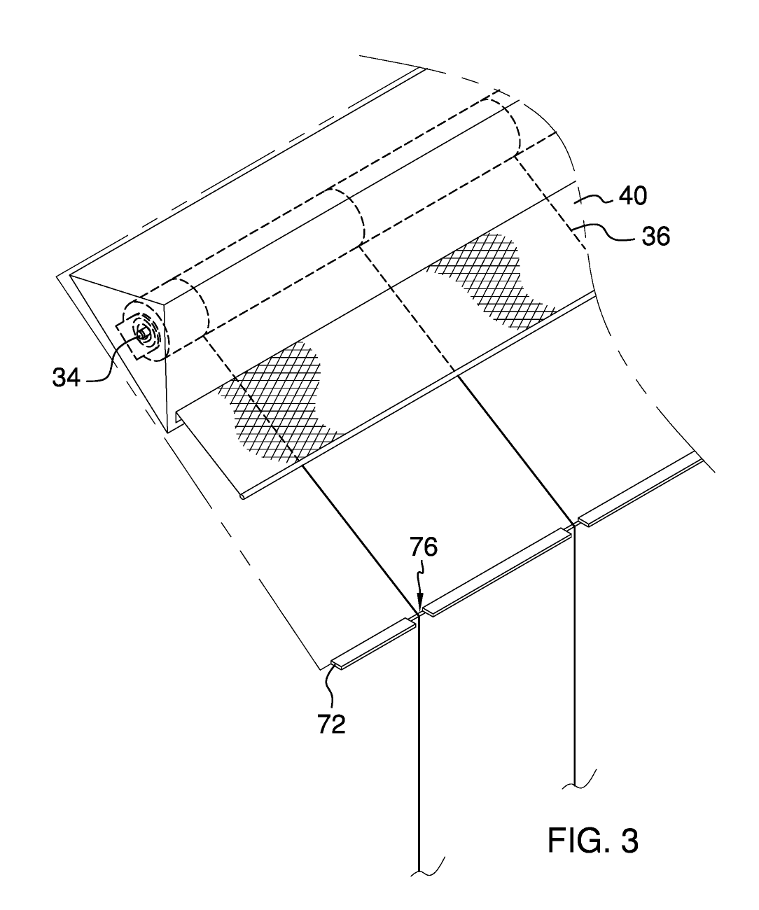

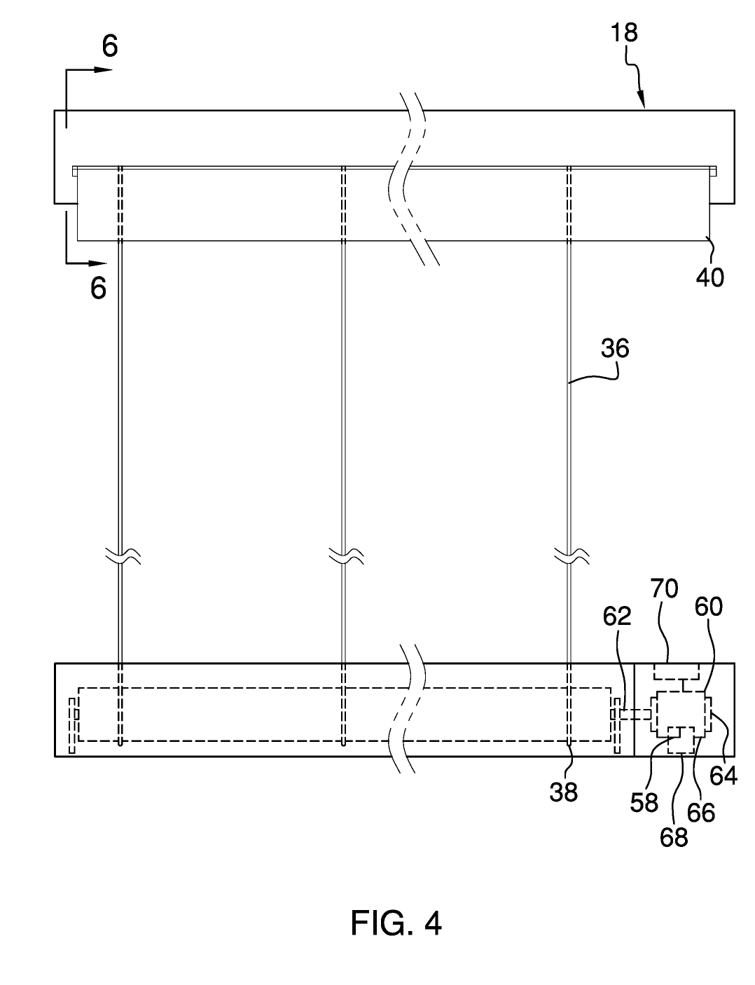

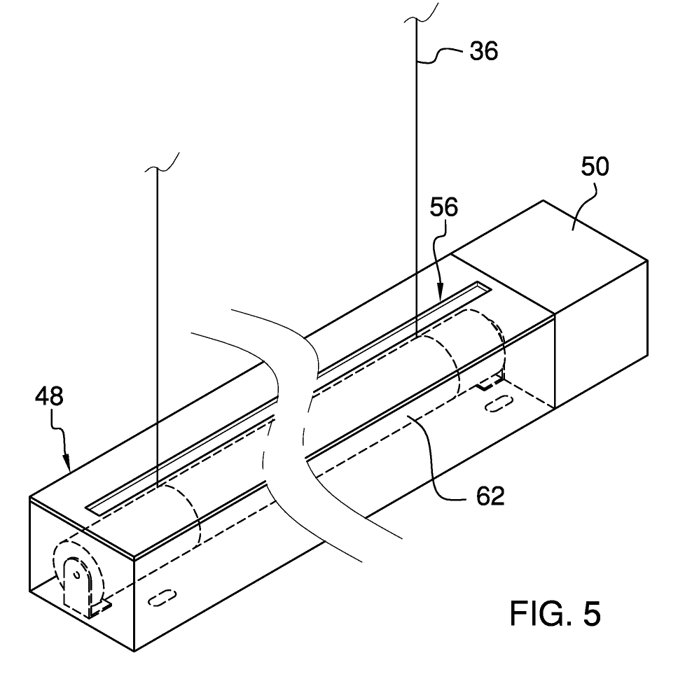

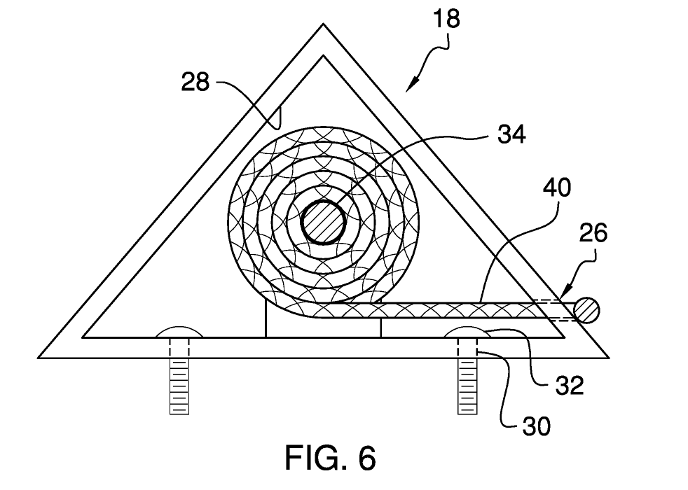

With reference now to the drawings, and in particular to FIGS. 1 through 6 thereof, a new dwelling protecting device embodying the principles and concepts of an embodiment of the disclosure and generally designated by the reference numeral 10 will be described.

As best illustrated in FIGS. 1 through 6, the wind damage abating system 10 generally comprises a dwelling 12. A covering 14 is mounted on a roof 16 of the dwelling 12 and is selectively extended downwardly from the roof 16 to protect the dwelling 12 from damaging winds. The covering 14 comprises a housing 18 that has a first lateral wall 20, a second lateral wall 22 and a perimeter wall 24 that is attached to and extends between the first lateral wall 18 and the second lateral wall 20.

The perimeter wall 24 has a releasing aperture 26 that extends into an interior 28 of the housing 18. The releasing aperture 26 is elongated and extends from the first lateral wall 20 to the second lateral wall 22. The perimeter wall 24 also has a plurality of mounting apertures 30 thereon. A plurality of fasteners 32 is included wherein each of said fasteners 32 secures the housing 18 to the dwelling 12. Each of the fasteners 32 extends through one of the mounting apertures 30 and into the roof 16.

A retracting spool 34 is rotatably mounted within the housing 18. The retracting spool 34 rotates about an axis that extends through the first and second lateral walls 20, 22. The retracting spool 34 is rotatable in a first direction and in a second direction and is biased to rotate in the first direction. The retracting spool 34 may be spring loaded such that it is biased in the first direction however, the retracting spool 34 may be biased in the first direction through other means.

A plurality of cables 36 is attached to the retracting spool 34 and extends outwardly from the releasing aperture 26. Each of the cables 36 is wound onto the retracting spool 34 when the retracting spool 34 rotates in the first direction. The retracting spool 34 rotates in the second direction when each of the cables 36 is pulled outwardly from the housing 18. Each of the cables 36 has a distal end 38 with respect to the retracting spool 34.

A panel 40 is attached to and extends across each of the cables 36. The panel 40 comprises a flexible material. The panel 40 extends outwardly from the housing 18 and downwardly adjacent to a side 42 of the dwelling 12 when each of the cables 36 is pulled outwardly from the housing 18 wherein the panel 40 protects the dwelling 12 from damaging winds. The panel 40 is retracted into the housing 18 when the retracting spool 34 rotates in the first direction.

An extracting unit 44 is positioned on a ground surface 46 adjacent to the dwelling 12. The extracting unit 44 is mechanically coupled to the covering 14. The extracting unit 44 pulls the covering 14 downwardly from the roof 16 of the dwelling 12. The extracting unit 44 comprises a container 48 that has a top wall 50, a bottom wall 52 and a peripheral wall 54 that extends between and is attached to the top wall 50 and the bottom wall 52. The top wall 50 has a slot 56 that extends into an interior of the container 48. The slot 56 is elongated. A control circuit 58 is mounted in the container 48. A motor 60 is mounted in the container 48. The motor 60 is in electrical communication with the control circuit 58.

An extracting roller 62 is rotatably mounted in the container 48 and is mechanically coupled to the motor 60. The motor 60 is actuated to rotate the extracting roller 62 in a deploying direction or in a storing direction. The distal end 38 of each of the cables 36 is coupled to the extracting roller 62. The extracting roller 62 pulls the covering 14 outwardly over a portion of the dwelling 12 when the extracting roller 62 is actuated in the deployment direction. The retracting spool 34 rotates in the first direction to retract the panel 14 into the housing 18 when the extracting roller 62 is rotated in the storing direction.

An actuator 64 is in electrical communication with the control circuit 58 to actuate the motor 60 in the deploying direction or in the storing direction. The actuator 64 includes a receiver 66 that is mounted in the container 48 and in electrical communication with the control circuit 58. A remote transmitter 68 is in communication with the receiver 66. The remote transmitter 68 sends wireless signals to the actuator 64 to actuate the motor 60 in the deploying direction or in the storing direction. A power supply 70 is electrically coupled to the control circuit 58. The power supply 70 may comprise a battery.

A flashing 72 is attached to the dwelling 12 and prevents damage to the dwelling 12 from unwinding the covering 14. The flashing 72 is attached to a lower edge 74 of the roof 16 of the dwelling 12. The flashing 72 has a plurality of grooves 76 therein. Each of the cables 36 is positioned in a corresponding one of the grooves 76 such that each of the grooves 76 guides the corresponding cable 36.

In use, the remote transmitter 68 is used to communicate with the actuator 64 to actuate the motor 60 into the deploying direction or the storing direction. In the deploying direction the extracting roller 62 pulls the cables 46 downwardly from the retracting spool 34 to pull the panel 40 outwardly from the housing 18 and adjacent to the dwelling 12. In the storing direction the extracting roller 62 rolls in a first direction and the retracting spool 34 pulls the cables 36 upwardly into the housing 18 such that the panel 40 is rolled completely around the retracting spool 34 and in the housing 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wind abatement system for protecting a building from damaging winds, said wind abatement system comprising:
a dwelling;
a covering being mounted on a roof of said dwelling, said covering being selectively extended downwardly from said roof protecting said dwelling from damaging winds; and
an extracting unit being positioned on a ground surface adjacent to said dwelling, said extracting unit being mechanically coupled to said covering, said extracting unit pulling said covering downwardly from said roof of said dwelling.

2. The wind abatement system according to claim 1, wherein said covering comprises a housing having a first lateral wall, a second lateral wall and a perimeter wall being attached to and extending between said first lateral wall and said second lateral wall, said perimeter wall having a plurality of mounting apertures thereon.

3. The wind abatement system according to claim 2, wherein said perimeter wall has a releasing aperture extending into an interior of said housing, said releasing aperture being elongated and extending from said first lateral wall to said second lateral wall.

4. The wind abatement system according to claim 3, further including a plurality of fasteners securing said housing to said dwelling, each of said fasteners extending through one of said mounting apertures and into said roof.

5. The wind abatement system according to claim 4, wherein said covering further includes a retracting spool being rotatably mounted within said housing, said retracting spool rotating about an axis extending through said first and second lateral walls, said retracting spool being rotatable in a first direction and in a second direction, said retracting spool being biased to rotate in said first direction.

6. The wind abatement system according to claim 5, wherein said covering further includes:
a plurality of cables being attached to said retracting spool and extending outwardly from said releasing aperture; and
a panel being flexible and being attached to and extending across each of said cables.

7. The wind abatement system according to claim 6, wherein each of said cables is wound onto said retracting spool when said retracting spool rotates in said first direction, said spool rotating in said second direction when each of said cables are pulled outwardly from said housing, each of said cables having a distal end with respect to said retracting spool.

8. The wind abatement system according to claim 7, wherein said panel extends outwardly from said housing and downwardly adjacent to a side of said dwelling when each of said cables are pulled outwardly from said housing wherein said panel protects said dwelling from damaging winds, said panel being retracted into said housing when said retracting spool rotates in said first direction, said panel comprising a flexible material.

9. The wind abatement system according to claim 8, wherein said extracting unit comprises a container having a top wall, a bottom wall and a peripheral wall extending between and being attached to said top wall and said bottom wall, said top wall having a slot extending into an interior of said container, said slot being elongated.

10. The wind abatement system according to claim 9, wherein said extracting unit further includes:
a control circuit being mounted in said container;
a motor being mounted in said container, said motor being in electrical communication with said control circuit; and
an extracting roller being rotatably mounted in said container and being mechanically coupled to said motor, said motor being actuated to rotate said extracting roller in a deploying direction or in a storing direction.

11. The wind abatement system according to claim 10, wherein said distal end of each of said cables is coupled to said extracting roller, said extracting roller pulling said covering outwardly over a portion of said dwelling when said extracting roller is actuated in said deployment direction said retracting spool rotating in said first direction to retract said panel into said housing when said extracting roller is rotated in said storing direction.

12. The wind abatement system according to claim 11, wherein said extracting unit further includes an actuator being in electrical communication with said control circuit to actuate said motor in said deploying direction or in said storing direction, said actuator including a receiver being mounted in said container and in electrical communication with said control circuit.

13. The wind abatement system according to claim 12, wherein said extracting unit further includes a remote transmitter being in communication with said receiver, said remote transmitter sending wireless signals to said actuator to actuate said motor in said deploying direction or in said storing direction.

14. The wind abatement system according to claim 6, further including a flashing being attached to said dwelling and preventing damage to said dwelling from unwinding said covering, said flashing being attached to a lower edge of said roof of said dwelling.

15. The wind abatement system according to claim 14, wherein said flashing has a plurality of grooves therein, each of said cables being positioned in a corresponding one of said grooves such that each of said grooves guides said cables.

16. A wind abatement system for protecting a building from damaging winds, said wind abatement system comprising:
a dwelling;
a covering being mounted on a roof of said dwelling, said covering being selectively extended downwardly from said roof protecting said dwelling from damaging winds, said covering comprising:
a housing having a first lateral wall, a second lateral wall and a perimeter wall being attached to and extending between said first lateral wall and said second lateral wall, said perimeter wall having a releasing aperture extending into an interior of said housing, said releasing aperture being elongated and extending from said first lateral wall to said second lateral wall, said perimeter wall having a plurality of mounting apertures thereon;
a plurality of fasteners securing said housing to said dwelling, each of said fasteners extending through one of said mounting apertures and into said roof;
a retracting spool being rotatably mounted within said housing, said retracting spool rotating about an axis extending through said first and second lateral walls, said retracting spool being rotatable in a first direction and in a second direction, said retracting spool being biased to rotate in said first direction;
a plurality of cables being attached to said retracting spool and extending outwardly from said releasing aperture, each of said cables being wound onto said retracting spool when said retracting spool rotates in said first direction, said spool rotating in said second direction when each of said cables are pulled outwardly from said housing, each of said cables having a distal end with respect to said retracting spool;
a panel being flexible and being attached to and extending across each of said cables, said panel extending outwardly from said housing and downwardly adjacent to a side of said dwelling when each of said cables are pulled outwardly from said housing wherein said panel protects said dwelling from damaging winds, said panel being retracted into said housing when said retracting spool rotates in said first direction, said panel comprising a flexible material;
an extracting unit being positioned on a ground surface adjacent to said dwelling, said extracting unit being mechanically coupled to said covering, said extracting unit pulling said covering downwardly from said roof of said dwelling, said extracting unit comprising:
a container having a top wall, a bottom wall and a peripheral wall extending between and being attached to said top wall and said bottom wall, said top wall having a slot extending into an interior of said container, said slot being elongated;
a control circuit being mounted in said container;
a motor being mounted in said container, said motor being in electrical communication with said control circuit;
an extracting roller being rotatably mounted in said container and being mechanically coupled to said motor, said motor being actuated to rotate said extracting roller in a deploying direction or in a storing direction said distal end of each of said cables being coupled to said extracting roller, said extracting roller pulling said covering outwardly over a portion of said dwelling when said extracting roller is actuated in said deployment direction said retracting spool rotating in said first direction to retract said panel into said housing when said extracting roller is rotated in said storing direction;
an actuator being in electrical communication with said control circuit to actuate said motor in said deploying direction or in said storing direction, said actuator including a receiver being mounted in said container and in electrical communication with said control circuit;
a remote transmitter being in communication with said receiver, said remote transmitter sending wireless signals to said actuator to actuate said motor in said deploying direction or in said storing direction; and
a flashing being attached to said dwelling and preventing damage to said dwelling from unwinding said covering, said flashing being attached to a lower edge of said roof of said dwelling, said flashing having a plurality of grooves therein, each of said cables being positioned in a corresponding one of said grooves such that each of said grooves guides said cables.
